(19) United States
(12) Patent Application Publication
(10) Pub. No.: US 2014/0128541 A1
(43) Pub. Date: May 8, 2014

(54) LATEX PROCESS TO ENABLE HIGH LOADINGS OF HYDROPHOBIC MONOMERS

(71) Applicant: XEROX CORPORATION, Norwalk, CT (US)

(72) Inventors: Valerie M. FARRUGIA, Oakville (CA); Richard Philip Nelson VEREGIN, Mississauga (CA); Karen Ann MOFFAT, Brantford (CA)

(73) Assignee: XEROX CORPORATION, Norwalk, CT (US)

(21) Appl. No.: 13/669,759

(22) Filed: Nov. 6, 2012

(51) Int. Cl. C09D 133/16; C08K 5/42

(52) U.S. Cl. 524/745

(57) ABSTRACT

A method for preparing a latex resin includes initiating polymerization of a starting reaction mixture including a first surfactant, a second surfactant, a solvent, a core monomer, and a hydrophobic monomer to form a latex seed in a reaction vessel, and mixing an additional amount of the second surfactant, the core monomer, and the hydrophobic monomer into the reaction vessel to form an emulsion including latex particles, wherein the first surfactant and the second surfactant may be the same or different.

### TECHNICAL FIELD

The present disclosure is generally related to latex resins, and more specifically, to a method of producing latex resins containing hydrophobic monomers and having improved stability.

### BACKGROUND

Typical emulsion polymerization methods comprise a free-radical initiated chain polymerization in which a monomer or a mixture of monomers is polymerized in the presence of an aqueous solution of a surfactant to form a latex. Using water for the inert continuous phase maintains low viscosity of the system and provides good heat transfer as well. The surfactant provides sites for particle nucleation/micelles and colloidal stability to the growing particles because the surfactant is absorbed at the particle-water interface. See Emulsion Polymerization and Emulsion Polymers, Eds. Peter A. Lovell and Mohamed El-Asser, New York: J Wiley, 1997.

Charging of many latex formulations is temperature and humidity specific. For example, latex resins may perform moderately in ambient (70° C., 20% RH) and low temperature, low humidity (60° C., 10% RH) conditions, but their performance may worsen in high temperature, high humidity (80° C., 80% RH) conditions. Proposed solutions to improve performance over a broader range of conditions include incorporating hydrophobic monomers into resins as charge control agents (CCAs). However, when hydrophobic monomers are introduced into an aqueous environment, they are insoluble, by definition, and result in slow monomer transport and low reactivity. Solutions to this problem include using a solvent mixture in which both hydrophobic and core monomers are soluble, and solubilizing the hydrophobic monomer into micelles that are dispersed in the water medium. The micellar copolymerization route results in high molecular weight latex, and in some cases does not properly incorporate the hydrophobic monomer or the latex destabilizes completely during polymerization and crashes out of the aqueous phase.

Thus, there remains a need for improving the incorporation of hydrophobic monomers and the stability of latex particles during polymerization.

### SUMMARY

The present disclosure provides a process of incorporating a hydrophobic monomer into a latex resin by a latex polymerization process in which a surfactant solution is partitioned such that additional surfactant is added after a latex seed is formed.

Particularly, the present disclosure provides a method for preparing a latex resin comprising initiating polymerization of a starting reaction mixture comprising a first surfactant, a second surfactant, a solvent, a core monomer, and a hydrophobic monomer to form a latex seed in a reaction vessel, and mixing an additional amount of the second surfactant, the core monomer, and the hydrophobic monomer into the reaction vessel to form an emulsion comprising latex particles, wherein the first surfactant and the second surfactant may be the same or different.

### EMBODIMENTS

As used herein, use of the singular includes the plural unless specifically stated otherwise. As used herein, use of “or” means “and/or,” unless stated otherwise. Furthermore, use of the term “including” as well as other forms, such as “includes” and “included” is not limiting.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The present disclosure describes a semi-continuous emulsion polymerization process for incorporating hydrophobic monomers into a latex resin. Higher loading of hydrophobic monomers may be achieved by partitioning the addition of surfactant during the polymerization process. Partitioning surfactant during latex polymerization increases surfactant loading without impacting latex particle size, and may exhibit ζ potential in stable ranges, including ζ potentials lower than about −45 mV, lower than about −60 mV, lower than about −65 mV, or lower than about −75 mV. This may be accomplished by partitioning the surfactant amount such that additional surfactant may be added at multiple time points during latex preparation, such as at and/or after seed particles have been generated. Partitioning the surfactant stabilizes the latex during polymerization, as compared to when all of the surfactant required for incorporation of the desired amount of the hydrophobic monomers is included in the initial aqueous phase. While not being bound by theory, it is believed that particle size may be determined by the number of seed particles generated in the initial stages of the emulsion polymerization. Thus, as long as there is no secondary nucleation, more surfactant may be added later in the process to increase latex stability by decreasing the ζ potential.

The semi-continuous emulsion polymerization process comprises a chain polymerization in which a core monomer is copolymerized with a hydrophobic monomer in an aqueous solution and in the presence of surfactant to form a latex resin. Latex seed particles are first formed by initiating polymerization in a suitable reaction vessel containing a starting reaction mixture comprising an aqueous medium, surfactant, core monomer, and hydrophobic monomer. After latex seed particles begin to form in the reaction mixture, additional amounts of core monomer, hydrophobic monomer, and surfactant are added to the reaction mixture in the reaction vessel as the polymerization reaction continues.

The starting reaction mixture may be formed by any suitable means. For example, each of the aqueous medium, surfactant, core monomer, and hydrophobic monomer may be added to the reaction vessel and then mixed together. Alternatively, an aqueous surfactant phase and a monomer mixture containing the core monomer and the hydrophobic monomer may be separately formed, and then the surfactant phase and a portion of the monomer mixture may be added to the reaction vessel and mixed together.

The starting reaction mixture may further contain chain transfer agents, charge control agents, charge enhancing additives, emulsifiers, pH buffering agents, electrolytes, catalyst agents, crosslinking agents, neutralization agents, continuous phase, such as water, reducing agents, redox couples consisting of an oxidizing agent and a reducing agent, and shortstopping agents, such as sodium dimethyldithiocarbamate and diethyl hydroxylamine

Polymerization may be initiated by any suitable means. For example, polymerization may be initiated through the addition of an initiator, by the application of heat, by the application of UV radiation, plasma initiation, ultrasonic initiation, enzymatic initiation, photo initiation or radiolysis initiation.

Polymerization may be allowed to continue for any suitable amount of time until the desired number of latex seed particles are formed. For example, polymerization may be allowed to continue from about 3 to about 48 hours, such as from about 5 to about 24 hours, or from about 8 to about 12 hours.

At one or more stages during particle formation, such as during or after latex seed formation, an additional amount of the core monomer, hydrophobic monomer, and surfactant are added to the reaction vessel. The additional core monomer, hydrophobic monomer, and surfactant may be added individually, or two or more components may be combined and then added to the reaction vessel. In particular, the additional core monomer, hydrophobic monomer, and surfactant, collectively or independent of each other, may be partitioned between latex seed formation and latex particle growth. The additional core monomer, hydrophobic monomer, and surfactant may be added at more than two time points, or may be metered into the reaction mixture on a continuous and tonic basis.

For example, a first surfactant and a solvent may be mixed in the reaction vessel. A second surfactant that may be the same as or different from the first surfactant, a core monomer, and a hydrophobic monomer may be combined in a separate vessel or container to form a monomer/surfactant emulsion. A portion of the monomer/surfactant emulsion may be transferred to the reaction vessel containing the first surfactant and solvent mixture and polymerization may be initiated to form a latex seed. The remaining portion of the monomer/surfactant emulsion may then be added and mixed into the reaction vessel to form an emulsion comprising latex particles. This remaining portion of the monomer/surfactant emulsion may be added all at once, or may be further partitioned to be added at two or more steps, or may be metered into the reaction mixture during particle formation.

Reaction conditions, temperature, and initiator loading may be varied to generate copolymers of various molecular weights, and structurally related starting materials may be polymerized using comparable techniques. For example, in forming the latex resin, the reaction mixture may be mixed for from about 1 minute to about 72 hours, such as from about 4 hours to about 24 hours, or from about 6 hours to about 12 hours, while keeping the temperature at from about 10° C. to about 100° C., such as from about 20° C. to about 90° C., from about 45° C. to about 75° C., or at about 65° C.

The resulting latex particles may be at least about 85 nm in size, such as at least about 90 nm, or at least about 100 nm.

Once a copolymer has been formed, it may be recovered from the emulsion by any known technique, including filtration, drying, centrifugation, spray drying, combinations thereof, and the like. Once recovered, the copolymer may be dried to powder form by any known method, including freeze drying, optionally in a vacuum, spray drying, combinations thereof, and the like.

Particles of the copolymer may have an average diameter of from about 40 to about 200 nm, such as from about 50 to about 150 nm, or from about 60 to about 120 nm.

If the size of the particles of the dried polymeric coating is too large, the particles may be homogenized or sonicated to further disperse the particles and break apart any agglomerates or loosely bound particles, thereby obtaining particles of the sizes noted above. Where used, a homogenizer may operate at a rate of from about 5,000 to about 10,000 rpm, such as from about 6,000 to about 9,750 rpm, or from about 7,000 to about 8,000 rpm for a period of time from about 0.5 to about 60 minutes, such as from about 5 to about 30 minutes, or from about 10 to about 20 minutes.

The resulting latex copolymers may have a number average molecular weight (Mn), as measured by gel permeation chromatography (GPC) of, for example, from about 60,000 to about 400,000, such as from about 100,000 to about 300,000, or from about 175,000 to about 250,000, and a weight average molecular weight (Mw) of, for example, from about 100,000 to about 800,000, such as from about 300,000 to about 700,000, or from about 400,000 to about 600,000, as determined by GPC using polystyrene standards.

The resulting latex copolymers may have a glass transition temperature (Tg) of from about 85° C. to about 140° C., such as from about 95 to about 130° C., or from about 98° C. to about 120° C. The copolymers may have a melt viscosity of from about 100 to about 3,000,000 Pa*S at about 130° C., such as from about 500 to about 2,000,000 Pa*S at about 130° C., or from about 1,000 to about 1,500,000 Pa*S at about 130° C.

### Solvents

Suitable solvents include water and/or organic solvents including toluene, benzene, xylene, tetrahydrofuran, acetone, acetonitrile, carbon tetrachloride, chlorobenzene, cyclohexane, diethyl ether, dimethyl ether, dimethyl formamide, heptane, hexane, methylene chloride, pentane, combinations thereof, and the like.

### Surfactants

The choice of particular surfactants or combinations thereof, as well as the amounts of each to be used, is within the purview of those skilled in the art. Suitable surfactants include ionic or nonionic surfactants. Additionally, one or more types of surfactant may be used in the polymerization process.

The surfactants may be present in an amount of from about 0.01 to about 15 wt % of the solids, such as from about 0.1 to about 10 wt % of the solids, or from about 0.5 to about 8 wt % of the solids.

Suitable anionic surfactants include sulfates and sulfonates, sodium lauryl sulfate, sodium dodecylbenzene sulfonate, sodium dodecylnaphthalene sulfate, dialkyl benzenealkyl sulfates and sulfonates, acids such as abietic acid available from Aldrich, NEOGEN R™ and NEOGEN SC™ obtained from Daiichi Kogyo Seiyaku Co., Ltd., combinations thereof, and the like. Other suitable anionic surfactants include DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates.

Suitable cationic surfactants include ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C₁₂, C₁₅, C₁₇-trimethyl ammonium bromides, combinations thereof, and the like. Other suitable cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride) available from Kao Chemicals, combinations thereof, and the like. A suitable cationic surfactant includes SANISOL B-50 available from Kao Corp., which is primarily a benzyl dimethyl alkonium chloride.

Suitable nonionic surfactants include alcohols, acids, and ethers, for example, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, combinations thereof, and the like. Commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™, and ANTAROX 897™ may be used.

### Monomers

The latex resin may include a copolymer of a core monomer and a hydrophobic monomer.

Suitable core monomers include aliphatic cycloacrylates and acidic acrylate monomers. Suitable aliphatic cycloacrylates include, for example, methylmethacrylate, cyclohexylmethacrylate, cyclopropyl acrylate, cyclobutyl acrylate, cyclopentyl acrylate, cyclohexyl acrylate, cyclopropyl methacrylate, cyclobutyl methacrylate, cyclopentyl methacrylate, isobornyl methacrylate, isobornyl acrylate, combinations thereof, and the like.

Hydrophobic monomers may have an alkane backbone structure that is composed primarily of hydrogen and carbon. Suitable hydrophobic monomers may also contain at least one halogen, such as fluorine, chlorine, or bromine. Hydrophobic monomers may also be halogenated and non-polar.

Suitable hydrophobic monomers may have a carbon atom to oxygen atom ratio (C/O) of about 5 or more, such as about 6 or more, or about 8 or more. Examples of suitable hydrophobic monomers include 1-tert-butyl-4-vinylbenzene, 1-vinyl-4-fluorobenzene, alpha-methyl styrene, 1-bromo-2-vinylbenzene, 3,5-bis(trifluoromethyl)phenyl methacrylate (TFMPMA), iso-butyl methacrylate, n-octyl methacrylate, stearyl acrylate, lauryl acrylate, 2-phenoxyethyl acrylate, isodecyl acrylate, isooctyl acrylate, isotridecyl acrylate, isobornyl acrylate, 1,3-butylene glycol diacrylate, 1,4-butanediol diacrylate, 1,6-hexanediol diacrylate, ethoxylated bisphenol A diacrylate, propoxylated neopentyl glycol diacrylate, tris(2-hydroxyethyl) isocyanurate triacrylate, and trimethylolpropane triacrylate.

The term “hydrophobic monomer” refers to any monomer with a water solubility of not more than about 0.02 g/100 g water, the term “very hydrophobic monomer” refers to any monomer with a water solubility of not more than about 0.01 g/100 g water, and the term “extremely hydrophobic monomer” refers to any monomer with a water solubility of not more than about 0.001 g/100 g water. The water solubility values are measured at 20° C. using deionized water as the solvent. The solubility of some monomers in water is as follows, measured at 20° C. and expressed as g/100 g water: acrylonitrile, 7.1; methyl acrylate, 5.2; vinyl acetate, 2.5; ethyl acrylate, 1.8; methyl methacrylate, 1.5; ethylene, 1.1; vinyl chloride, 0.60; butyl acrylate, 0.16; styrene, 0.03; 2-ethylhexyl acrylate, 0.01; vinyl neo-pentanoate, 0.08; vinyl 2-ethylhexanoate, <0.01; vinyl neo-nonanoate, <0.001; vinyl neo-decanoate, <0.001; vinyl neo-undecanoate, <0.001; and vinyl neo-dodecanoate, <0.001. These solubilities are from D. R. Bassett, “Hydophobic Coatings from Emulsion Polymers,” Journal of Coatings Technology, January 2001. Most of the neo-monomers exhibit much lower solubilities than the other monomers, with the exception of 2-ethylhexyl acrylate.

Essentially any monomer with a water solubility of not more than about 0.02 g/100 g water can be employed in the process of the invention. These monomers include vinyl esters of branched mono-carboxylic acids having a total of 8 to 12 carbon atoms in the acid residue moiety and 10 to 14 total carbon atoms such as, for example, vinyl 2-ethyl hexanoate, vinyl neo-nonanoate, vinyl neo-decanoate, vinyl neo-undecanoate, vinyl neo-dodecanoate and mixtures thereof (Shell Corporation sells vinyl neo-nonanoate, vinyl neo-decanoate and vinyl neo-undecanoate under the trade names, VeoVa 9, VeoVa 10 and VeoVa 11, respectively, while Exxon sells vinyl neo-dodecanoate and vinyl neo-decanoate under the trade names, Exxar 12 and Exxar 10, respectively). Preferred monomers include higher vinyl esters. The term “higher vinyl ester” refers to a vinyl ester containing from about 8 to about 12 carbon atoms in the acid residue moiety. The higher vinyl esters may be branched vinyl esters, such as vinyl pivalate, vinyl neo-nonanoate, vinyl 2-ethyl hexanoate, vinyl neo-decanoate, vinyl neo-undecanoate, vinyl neo-dodecanoate, and mixtures thereof. The monomer mixture may comprise at least one higher branched vinyl ester.

Additional examples of hydrophobic monomers include vinyl 2-ethylhexanoate, vinyl laurate, vinyl stearate, vinyl alkyl or aryl ethers with (C9-C30) alkyl groups such as stearyl vinyl ether; (C6-C30) alkyl esters of (meth-)acrylic acid, such as hexyl (meth)acrylate, heptyl (meth)acrylate, octyl (meth)acrylate, isooctyl acrylate, isononyl acrylate, decyl (meth)acrylate, isodecyl (meth)acrylate, dodecyl (meth)acrylate, 2-ethylhexyl (meth)acrylate, benzyl (meth)acrylate, lauryl (meth)acrylate, oleyl (meth)acrylate, palmityl (meth)acrylate, and stearyl (meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1-hexene, 1-octene, isobutylene and isoprene; and the like, provided, however, that any monomer that has a solubility of more than about 0.02 g/100 g water is not within the definition of hydrophobic. Mixtures of hydrophobic monomers may be employed.

The hydrophobic monomers may be added to a mixture of a surfactant and a core monomer in an amount of greater than about 4 mol % based on 1 mole of the mixture, such as greater than about 5 mol %, or greater than about 8 mol %.

The latex emulsion may include a copolymer derived from an aliphatic cycloacrylate and at least one additional acrylate. For example, the latex emulsion may include a copolymer of cyclohexylmethacrylate with 3,5-bis(trifluoromethyl)phenyl methacrylate (TFMPMA). The cyclohexylmethylmethacrylate may be present in an amount of from about 99.9 to about 70 mol %, such as from about 99.0 to about 80 mol %, or from about 98 to about 85 mol %, based on the total moles of latex emulsion.

### Initiators

Initiators may be added for formation of the latex. Examples of suitable initiators include water soluble initiators, such as ammonium persulfate, sodium persulfate, and potassium persulfate, organic soluble initiators including organic peroxides, and azo compounds including Vazo peroxides, such as VAZO 64™, 2-methyl 2-2′-azobis propanenitrile, VAZO 88™, 2-2′-azobis isobutyramide dehydrate, and combinations thereof. Other suitable water-soluble initiators which may be used include azoamidine compounds, for example 2, 2′-azobis(2-methyl-N-phenylpropionamidine) dihydrochloride, 2,2′-azobis[N-(4-chlorophenyl)-2-methylpropionamidine]dihydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)-2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis {2-[1-(2-hydroxyethyl)-2-imidazolin-2-yl]propane}dihydrochloride, combinations thereof, and the like.

Initiators may be added in any suitable amount, such as from about 0.01 to about 8 wt %, from about 0.02 to about 5 wt %, or from about 0.1 to about 3 wt % of the monomers.

### Chain Transfer Agents

Chain transfer agents may also be used in forming the latex resin. Suitable chain transfer agents include dodecane thiol, octane thiol, carbon tetrabromide, combinations thereof, and the like, in amounts from about 0.01 to about 10 wt %, such as from about 0.01 to about 5 wt %, or from about 0.1 to about 3 wt % of monomers, to control the molecular weight properties of the latex resin.

### Charge Control Agents

The latex resin may further comprise a charge control agent (CCA). Suitable CCAs include acidic acrylates and dialkylaminoacrylates. Suitable acidic acrylates include acrylic acid, methacrylic acid, beta-carboxyethyl acrylate, combinations thereof, and the like. Suitable dialkylaminoacrylates include, for example, dimethylamino ethyl methacrylate (DMAEMA), 2-(dimethylamino) ethyl methacrylate, diethylamino ethyl methacrylate, diethylamino butyl methacrylate, methylamino ethyl methacrylate, combinations thereof, and the like.

Where the cycloacrylate is combined with a charge control agent, the cycloacrylate may be present in a copolymer of the latex resin in an amount of from about 70 to about 99.9 wt % of the copolymer, such as from about 80 to about 99.0 wt %, or from about 85 to about 98 wt %. The charge control agent may be present in such a copolymer in an amount of from about 0.05 to about 10 wt % of the copolymer, such as from about 0.1 to about 8 wt %, or from about 0.5 to about 5 wt %.

### Charge Enhancing Additives

One or more charge enhancing additives may be added to the latex copolymer, including particulate amine resins, such as melamine, certain fluoropolymer powders, such as alkyl-amino acrylates and methacrylates, polyamides and fluorinated polymers, such as polyvinyl fluoride and poly(tetrafluoroethylene), and fluoroalkyl methacrylates, such as 2,2,2-trifluoroethyl methacrylate. Other charge enhancing additives include quarternary ammonium salts, including distearyl dimethyl ammonium methyl sulfate (DDAMS), bis[1-[(3,5-disubstituted-2-hydroxyphenyl)azo]-3-(mono-substituted)-2-naphthalenolato(2-)]chromate(1-), ammonium sodium and hydrogen (TRH), cetyl pyridinium chloride (CPC), FANAL PINK® D4830, combinations thereof, and the like, and other effective known charge agents or additives.

The charge additive components may be added in an amount of from about 0.05 to about 20 wt %, from about 0.5 to about 5 wt %, or from about 1 to about 3 wt %, based, for example, on the sum of the weights of polymer/copolymer, conductive component, and other charge additive components.

The addition of conductive components may increase the negative triboelectric charge imparted to the latex copolymer, and therefore, further increase the negative charge imparted to a toner in an electrophotographic development system. These components may be included by roll mixing, tumbling, milling, shaking, electrostatic powder cloud spraying, fluidized bed, electrostatic disc processing, and an electrostatic curtain, as described, for example, in U.S. Pat. No. 6,042,981, the disclosure of which is hereby incorporated by reference in its entirety.

### Latex Resins

The latex resins produced by the processes described above may be used in xerographic materials. For example, the latex resins may be used to coat carrier cores of any known type by various known methods. The coated carriers may then be incorporated with a toner to form a developer for electrophotographic printing. Suitable coated carriers and toners include, for example, those described in U.S. Pat. No. 8,227,163, the disclosure of which is incorporated herein by reference in its entirety. Such toner compositions may include optional colorants, waxes, and other additives. Toners may be formed utilizing any method within the purview of those skilled in the art including emulsion aggregation methods.

The processes described above may additionally be used to incorporate hydrophobic monomers into a variety of monomer matrixes to produce latex resins used in other compositions, including paints, biomedical products, coatings, health and beauty aids, and other applications that typically use latex.

### EXAMPLES

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 30° C.

### Comparative Example 1

### Preparation of Latex with 1 mol % 3,5-bis(trifluoromethyl)phenyl methacrylate (TFMPMA)

Latex emulsions comprising polymer particles generated from the emulsion polymerization of cyclohexylmethacrylate and hydrophobic fluorinated monomers with non-partitioned surfactant were prepared as follows.

0.0026 moles (0.750 g) of sodium lauryl sulfate surfactant in 21.14 moles (381 g) of de-ionized water was added to a 1 L Büchi equipped with a P4 paddle stirrer, a nitrogen inlet and outlet, heating jacket connected to a bath to control the temperature, and a valve on the bottom of the reactor to discharge the latex. The Büchi was heated to 65° C. and stirred at 450 revolutions per minute (RPM).

Meanwhile, 666 mmol (112 g) cyclohexylmethacrylate monomer and 0.0067 moles (1.998 g) TFMPMA were added to a beaker and stirred at 800 RPM to emulsify the monomer solution.

10 wt % of monomer seed was taken out of the beaker and added to the Büchi. Then, 0.0021 moles (0.479 g) ammonium persulfate initiator dissolved in 0.222 moles (4.00 g) de-ionized water was added to the Büchi. After 40 minutes, the remaining contents from the beaker were slowly metered into the Büchi at a rate of 0.9 g per minute using a pump. Once all of the monomer emulsion was charged into the Büchi, the temperature was held at 65° C. for an additional 3 hours to complete the reaction. Full cooling was applied to the reactor to bring the temperature to below 35° C. A liquid sample was taken to measure particle size on a Nanotrac Particle Size Analyzer (Microtrac) and zeta potential on a Zetasizer (Malvern). The remaining product was dried to a powder form using a freeze-drier apparatus.

### Comparative Example 2

### Preparation of Latex with 5 mol % 3,5-bis(trifluoromethyl)phenyl methacrylate (TFMPMA)

Latex emulsions comprising polymer particles generated from the emulsion polymerization of cyclohexylmethacrylate and hydrophobic fluorinated monomers with non-partitioned surfactant were prepared as follows.

0.0026 moles (0.750 g) of sodium lauryl sulfate surfactant in 21.14 moles (381 g) of de-ionized water was added to a 1 L Büchi equipped with a P4 paddle stirrer, a nitrogen inlet and outlet, heating jacket connected to a bath to control the temperature, and a valve on the bottom of the reactor to discharge the latex. The Büchi was heated to 65° C. and stirred at 450 revolutions per minute (RPM).

Meanwhile, 666 mmol (112 g) cyclohexylmethacrylate monomer and 0.033 moles (9.92 g) TRMPMA were added to a beaker and stirred at 800 RPM to emulsify the monomer solution.

10 wt % of monomer seed was taken out of the beaker and added to the Büchi. Then, 0.0021 moles (0.479 g) ammonium persulfate initiator dissolved in 0.222 moles (4.00 g) de-ionized water was added to the Büchi. After 40 minutes, the remaining contents from the beaker were slowly metered into the Büchi at a rate of 0.9 g per minute using a pump. Once all of the monomer emulsion was charged into the Büchi, the temperature was held at 65° C. for an additional 3 hours to complete the reaction. Full cooling was applied to the reactor to bring the temperature to below 35° C. The reactor was opened to observe contents because the material would not discharge from the bottom valve. The latex had coagulated into a gelatinous material. Some of the material was dried for analytical analysis.

### Example 1

Preparation of Latex with 4.1 mol % 3,5-bis(trifluoromethyl)phenyl methacrylate (TFMPMA)—36% Extra Sodium lauryl sulfate (SLS)

Latex emulsions comprising polymer particles generated from the emulsion polymerization of cyclohexylmethacrylate and novel charge control monomer with partitioned surfactant were prepared as follows.

0.00111 moles (0.320 g) of sodium lauryl sulfate surfactant in 14.05 moles (253 g) of de-ionized water was added to a 1 L Büchi equipped with a P4 paddle stirrer, a nitrogen inlet and outlet, heating jacket connected to a bath to control the temperature, and a valve on the bottom of the reactor to discharge the latex. The Büchi was heated to 65° C. and stirred at 450 RPM.

Meanwhile, 2.43 mmol (0.701 g) of sodium lauryl sulfate surfactant, 7.086 moles (128 g) de-ionized water, 0.666 moles (112 g) cyclohexylmethacrylate monomer, and 0.027 moles (8.09 g) TFMPMA were added to a beaker and stirred at 800 RPM to emulsify the monomer/aqueous surfactant solution.

10 wt % of monomer seed was taken out of the beaker and added to the Büchi. Then, 2.1 mmol (0.479 g) ammonium persulfate initiator dissolved in 222 mmol (4.00 g) de-ionized water was added to the Büchi. After 40 minutes, the remaining contents from the beaker were slowly metered into the Büchi at a rate of 0.9 g per minute using a pump. Once all of the monomer emulsion was charged into the Büchi, the temperature was held at 65° C. for an additional 3 hours to complete the reaction. Full cooling was applied to the reactor to bring the temperature to below 35° C. A liquid sample was taken to measure particle size on a Nanotrac Particle Size Analyzer (Microtrac) and zeta potential on a Zetasizer (Malvern). The remaining product was dried to a powder form using a freeze-drier apparatus.

### Results

The following Table 1 shows analytical data for the latexes made. The latex made by the non-partitioned process with 5 mol % TFMPMA did not form a stable emulsion. Once the process was switched to the partitioned method for 4.1 mol % TFMPMA, a stable emulsion with excellent particle size was produced.

TABLE 1

| | | Sample ID | | |
|---|---|---|---|---|
| | | Comparative | Comparative | Example |
| | | Ex. 1-1 mol % | Ex. 2-5 mol % | 1-4.1 mol |
| | | TFMPMA | TFMPMA | % TFMPMA |
| | | Type | | |
| | | | | partitioned - |
| | | non-partitioned | non-partitioned | 36% SLS |
| Scale | | 1-L Buchi | 1-L Buchi | 1-L Buchi |
| DSC | T_{gOnset} (° C.) | 100.3 | 98.4 | 99.5 |
| Analysis | T_{gMid} (° C.) | 108.0 | 107.1 | 107.1 |
| | T_{gOffset} (° C.) | 115.7 | 115.8 | 114.6 |
| GPC | Mw (K) | 721.16 | 610.03 | 499.89 |
| | Mn (K) | 361.678 | 233.753 | 175.18 |
| | P.D. | 1.99 | 2.61 | 2.85 |
| | Mp (K) | 850.17 | 570.24 | 409.71 |
| GC | % CCA | 0.025 | Latex crashed, | N/A |
| | Residual | | unstable | |
| | % CHMA | 0.182 | | 0.614 |
| | Residual | | | |
| PSD | D50 (nm) | 89.5 | | 98.7 |
| (Nanotrac) | MV (nm) | 93.8 | | 100.8 |

| | | |
|---|---|---|
| Zeta Potential (mV) | −54.4 | −58.7 |

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for preparing a latex resin comprising:
initiating polymerization of a starting reaction mixture comprising a first surfactant, a second surfactant, a solvent, a core monomer, and a hydrophobic monomer to form a latex seed in a reaction vessel; and
mixing into the reaction vessel an additional amount of the second surfactant, the core monomer, and the hydrophobic monomer to form an emulsion comprising latex particles,
wherein the first surfactant and the second surfactant may be the same or different.

2. The method of claim 1, wherein the starting reaction mixture is formed by:
mixing the first surfactant and the solvent in the reaction vessel;
combining the second surfactant, the core monomer, and the hydrophobic monomer to form a monomer/surfactant emulsion; and
transferring a portion of the monomer/surfactant emulsion to the reaction vessel.

3. The method of claim 1, wherein initiating polymerization occurs by at least one of adding an initiator to the starting reaction mixture, applying heat to the starting reaction mixture, and applying UV radiation to the starting reaction mixture.

4. The method of claim 1, wherein the hydrophobic monomer has a carbon to oxygen (C/O) ratio of at least about 5.

5. The method of claim 1, wherein the hydrophobic monomer comprises a halogen.

6. The method of claim 5, wherein the halogen is selected from the group consisting of fluorine, chlorine, and bromine.

7. The method of claim 1, wherein the hydrophobic monomer is selected from the group consisting of 1-tert-butyl-4-vinylbenzene, 1-vinyl-4-fluorobenzene, alpha-methyl styrene, 1-bromo-2-vinylbenzene, 3,5-bis(trifluoromethyl)phenyl methacrylate (TFMPMA), iso-butyl methacrylate, n-octyl methacrylate, stearyl acrylate, lauryl acrylate, 2-phenoxyethyl acrylate, isodecyl acrylate, isooctyl acrylate, isotridecyl acrylate, isobornyl acrylate, 1,3-butylene glycol diacrylate, 1,4-butanediol diacrylate, 1,6-hexanediol diacrylate, ethoxylated bisphenol A diacrylate, propoxylated neopentyl glycol diacrylate, tris(2-hydroxyethyl) isocyanurate triacrylate, and trimethylolpropane triacrylate.

8. The method of claim 7, wherein the hydrophobic monomer is TFMPMA.

9. The method of claim 1, wherein the hydrophobic monomer is present in an amount of greater than about 4 mol % based on total moles of the mixture.

10. The method of claim 1, wherein the first surfactant is sodium lauryl sulfate.

11. The method of claim 1, wherein the first surfactant and the second surfactant are the same.

12. The method of claim 1, wherein the latex resin comprises an aliphatic cycloacrylate.

13. The method of claim 12, wherein the aliphatic cycloacrylate is selected from the group consisting of cyclohexylmethacrylate, cyclopropyl acrylate, cyclobutyl acrylate, cyclopentyl acrylate, cyclohexyl acrylate, cyclopropyl methacrylate, cyclobutyl methacrylate, cyclopentyl methacrylate, isobornyl methacrylate, idobornyl acrylate, and combinations thereof.

14. The method of claim 12, wherein the latex resin further comprises an acidic acrylate or a dialkylaminoacrylate.

15. The method of claim 14, wherein the latex resin comprises an acidic acrylate selected from the group consisting of acrylic acid, methacrylic acid, β-carboxyethyl acrylate, and combinations thereof.

16. The method of claim 14, wherein the latex resin comprises a dialkylaminoacrylate selected from the group consisting of dimethylamino ethyl methacrylate, 2-(dimethylamino ethyl methacrylate, diethylamino ethyl methacrylate, dimethylamino butyl methacrylate, methylamino ethyl methacrylate, and combinations thereof.

17. The method of claim 1, wherein the core monomer is a cyclohexylmethacrylate monomer.

18. The method of claim 1, wherein the latex resin has a zeta potential of about −45 to about −75 mV.

19. A carrier latex resin prepared by the method of claim 1.

20. A coated carrier comprising a core coated with the carrier latex resin of claim 19.
